(19) United States
(12) Patent Application Publication
(10) Pub. No.: US 2009/0024986 A1
(43) Pub. Date: Jan. 22, 2009

(54) RUNTIME CODE MODIFICATION

(75) Inventors: Henricus Johannes Maria Meijer, Mercer Island, WA (US); Brian C. Beckman, Newcastle, WA (US); Bruno S. Bozza, Redmond, WA (US); Jeffrey van Gogh, Redmond, WA (US); Wei Zhu, Sammamish, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/779,946

(22) Filed: Jul. 19, 2007

(51) Int. Cl. G06F 9/45

(52) U.S. Cl. 717/137

(57) ABSTRACT

Source languages are translated to target dynamic programming languages. Runtime functionality including reflection and/or dynamic code modification exposed by a source language is mapped to a dynamic language implementation such as that of a script language. Target language dynamism is leveraged to efficiently support runtime functionality in a source language that is more static, for example.

### BACKGROUND

Computer programs are groups of instructions that describe actions to be performed by a computer or other processor-based device. When a computer program is loaded and executed on computer hardware, the computer will behave in a predetermined manner by following the instructions of the computer program. Accordingly, the computer becomes a specialized machine that performs the tasks prescribed by the instructions.

A programmer using one or more programming languages creates the instructions comprising a computer program. Typically, source code is specified or edited by a programmer manually and/or with help of an integrated development environment (IDE). Subsequently, the source code can be compiled or otherwise transformed by another program into computer instructions executable by a computer or like device.

By way of example, a programmer may choose to implemented code utilizing an object-oriented programming language (e.g., Visual Basic, C#, Java . . . ). In accordance with such a paradigm, programmers create a number of classes identifying properties and characteristics of an abstract thing as well as methods describing class behavior or abilities. Specific programmatic logic can then be specified as interactions between instances of classes or objects, among other things. Subsequently, executable code for a particular machine can be produced by an associated compiler. Alternatively, code can be transformed into intermediate code for a target virtual machine to facilitate execution on multiple computer platforms via further compilation or interpretation of the intermediate code.

Conventionally, programming languages are either statically typed or dynamically typed. Types provide constraints on the interpretation of data in accordance with a language type system. Accordingly, types can be utilized to detect programming errors via a type checking. In this manner, a degree of program safety can be obtained by detecting meaningless or likely invalid code as a function of data types. This can be accomplished either statically or dynamically.

A statically typed language enables a program to be type checked at compile time. Accordingly, all types are known at compile time, for example by explicit specification or type inference. Static typing is beneficial in that errors can be detected prior to execution and programs can execute very efficiently. Further, design time experience can be improved since feedback or assistance can be afforded as a function of known types

Dynamically typed languages differ in that they are type checked at runtime. As a consequence, types need not be explicitly specified or inferred prior to use, rather they are determined during execution. Dynamically typed languages allow more programmatic flexibility than static typed languages enabling programmers to specify code would not be allowed based on restrictions of a static type system. Furthermore, dynamically typed languages are easier to use, as programmers need not be concerned with type specification.

Dynamic languages have additional advantages beyond those associated with typing. In particular, dynamic languages and associated runtimes such as ECMAScript and dialects thereof, Perl, Scheme and the like natively support true runtime functionality including reflection and dynamic code generation and deletion, among other things.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to implementation and exposure of runtime functionality. A source language program can be translated to a dynamic language for execution. More particularly, runtime functionality including reflection and dynamic code modification afforded by a source language can be implemented in a target dynamic language and executed utilizing an associated dynamic runtime. In one instance, this can correspond to embedding a source language runtime into a target dynamic language runtime. Additionally or alternatively, target dynamic language features can be exposed upward into a source language.

In accordance with one aspect of the disclosed subject matter, a compiler is provided for translating source language code to target dynamic language code. The compiler can simply map corresponding source and target code and/or construct target language support for source language semantics/constructs. According to one specific aspect, a compile time compiler can be bootstrapped to produce a compiler in the target language to facilitate runtime compilation of dynamically generated or loaded code.

In addition to facilitating dynamic code extension, code deletion or unloading is also provided in accordance with another aspect of the disclosed subject matter. A target language implementation of source language code can be produced in a manner that leverages a target language's ability to dynamically delete code. In this manner, source language fields, types and/or classes, among other things can be unloaded.

In accordance with yet another aspect of the disclosed subject matter, objects are marshaled to facilitate interoperability been a source and target languages. For example, metadata including fields and methods can be added to a more primitive target dynamic language object to facilitate source language processing or removed to aid target language processing.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a dynamic language targeted compiler is illustrated in accordance with an aspect of the disclosed subject matter.

FIG. 2 is a block diagram of a representative translation component.

FIG. 3 is a block diagram of an exemplary code execution environment.

FIG. 4 is a block diagram of a dynamic runtime system in accordance with an aspect of the disclosed subject matter.

FIG. 5 is a block diagram of an exemplary code execution system including static and dynamic portions.

FIG. 6 is a block diagram of a dynamic runtime system that employs a service in accordance with an aspect of the disclosed subject matter.

FIG. 7 is a block diagram of a computer program in accordance with an aspect of the disclose subject matter.

FIG. 8 is a block diagram of a data marshalling system in accordance with an aspect of the disclosed subject matter.

FIG. 9 is a flow chart diagram of method of program compilation of source language runtime functionality.

FIG. 10 is a flow chart diagram of a method of program execution in accordance with an aspect of the disclosed subject matter.

FIG. 11 is a flow chart diagram of a method of program execution in accordance with an aspect of the disclosed subject matter.

FIG. 12 is a flow chart diagram of a method of program interaction in accordance with an aspect of the disclosed subject matter.

FIG. 13 is a schematic block diagram illustrating a suitable operating environment for aspects of the subject disclosure.

FIG. 14 is a schematic block diagram of a sample-computing environment.

### DETAILED DESCRIPTION

Systems and methods are provided to facilitate runtime code modification. Source language code (e.g., static and/or structured) is implemented on top of a dynamic and/or unstructured runtime. In other words, source language code is translated into dynamic and/or unstructured code. In this manner, reflection and/or dynamic code modification can be effected efficiently in terms of a dynamic runtime rather than attempting to simulate dynamism in a static world. Furthermore, dynamic communication protocols can be translated to enable interaction via structured language functionality. Alternatively, structured language communication constructs can be converted to unstructured constructs for interaction by a dynamic environment.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

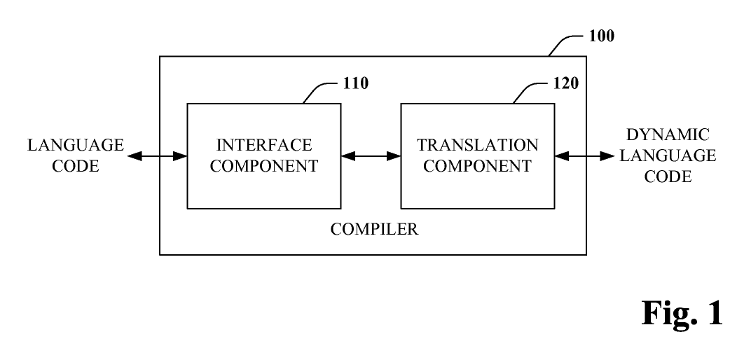

Referring initially to FIG. 1, a dynamic language targeted compiler 100 (also referred to simply as compiler 100) is illustrated in accordance with an aspect of the claimed subject matter. The compiler 100 acquires code of a first language and produces code of a second dynamic language, wherein the semantics of the first language are captured by or implemented in the code of the second language. More particularly, the compiler component 100 includes an interface component 110 and a translation component 120. The interface component 110 can receive, retrieve or otherwise obtain or acquire a source language for compilation. The translation component 120 translates or transforms an acquired source language to a target dynamic language. In one instance, the targeted dynamic language can be a script language including but not limited to ECMAScript, or various dialects thereof (e.g. JavaScript, JScript . . . ). Such dynamic languages by nature enable code to be added and/or removed at runtime. Furthermore, support for these languages including their associated runtimes or engines are widely available and accessible on World Wide Web (Web) and are embedded in many software applications including web browsers and document publishers/viewers, amongst others.

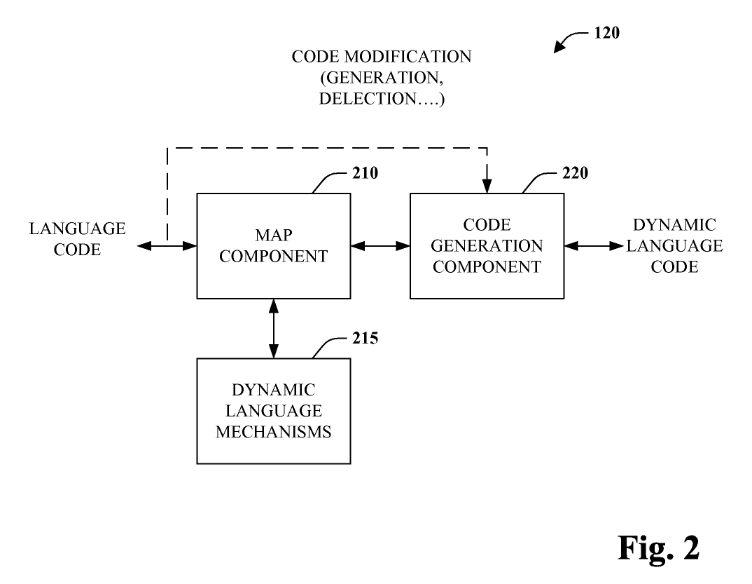

Turning attention to FIG. 2, a representative translation component 120 is illustrated in accordance with an aspect of the claimed subject matter. The translation component 120 includes a map component 210 communicatively coupled to a dynamic data structure component 215 and a code generation component 220. The map component 210 interacts with a given code source specified in a particular language and maps programmatic constructs in the source language to corresponding constructs in the dynamic language provided by the dynamic data structure component 215. The code generation component 220 can utilize the mapping information to construct dynamic language code that captures the semantics of the source code.

In some instance, there may be a direct mapping of constructs in the source to constructs in the target. In other cases, constructs or programmatic logic may need to be constructed by the code generation component 220 alone or in combination with the map component 210 and/or dynamic data structure component 215. By way of example, dynamic languages such ECMAScript and/or dialects thereof are unstructured, weakly typed and prototype-based, whereas a source language such as Visual Basic, C# or Java can be structured, strongly typed and object-oriented. In this case, constructs and logic of a natively unstructured language can be employed to capture structural functionality associated with a source language. Similarly, generated dynamic code can implement strong typing and object-oriented features of source language code.

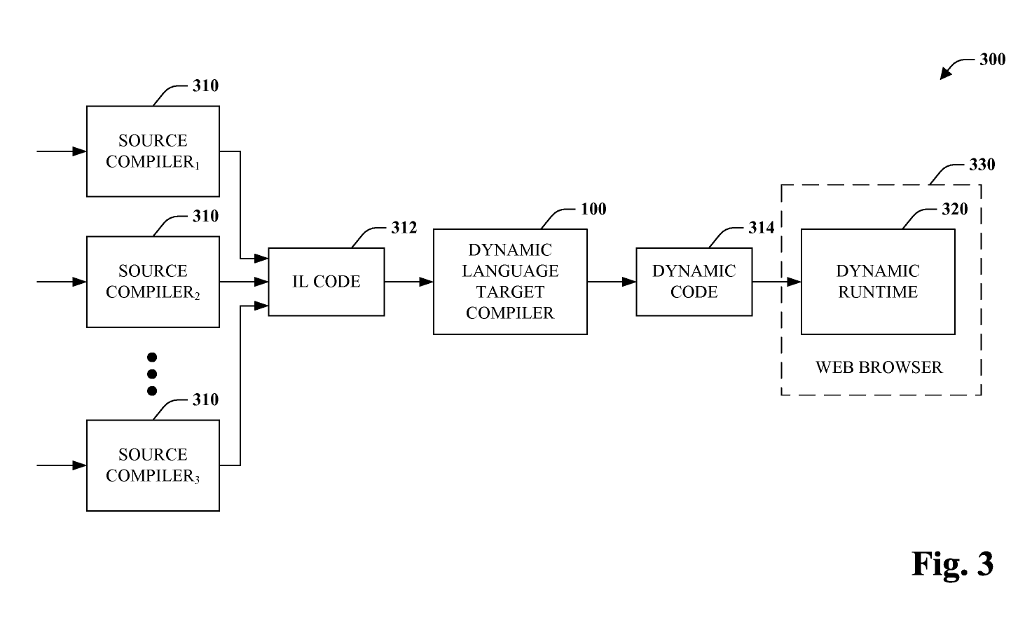

In accordance with one aspect, the compiler 100 can be employed in a compile time system for translating code to a target dynamic language. Referring briefly to FIG. 3, an exemplary code execution environment 300 is illustrated. As shown, the environment 300 can include a plurality of source code compilers 310 (SOURCE COMPILER₁-SOURCE COMPILER_{N}, where N is greater than 1) operable to compile various source code languages into intermediate language (IL) code 312. The source languages can be any language representation desired to be compiled to dynamic code including Visual Basic, C# and Java, among others.

The aforementioned compiler 100 can acquire intermediate language code 312 and produce dynamic code 314 that preserves the semantics described by the intermediate language code 312. Although some language constructs can be direct translated from source to target language, some constructs may require reconstruction in the target language. For example, structured language functionality captured by the IL code 312 can be implemented or preserved in natively unstructured dynamic code 314.

Subsequent to generation, the dynamic code 314 can be interpreted or executed by dynamic runtime system or component 320. In one embodiment, the runtime component 320 can be embedded within a web browser application 330. Accordingly, the dynamic language can correspond to a browser script executable therein. It is to be noted that since the compiler 100 compiles intermediate language code 312 to dynamic language code 314 executable by the dynamic runtime 220 within a browser, any language that compiles to IL can be run in a browser. As a result, applications can be specified by programmers in any desired language, which can subsequently be translated and executed dynamically in a web browser. Further yet, legacy applications can be transformed to browser executable programs.

A powerful concept in programming languages is an ability to employ runtime reflection by reifying internal runtime structures as program visible objects. Even more powerful is the ability to modify and/or extend internal runtime structures. Some conventional languages implementations attempt to capture this functionality in low-level assembly language (e.g., x86). However, the runtime infrastructure is quite involved since the underlying machinery is not very expressive. As a result, it is rather complex to implement runtime reflection and in particular, runtime code generation, modification or the like. As a concrete example, adding expando behavior or the ability to extend instances of classes with new members dynamically is a daunting task and virtually impossible because of the encoding of objects.

In this case, however, the target language is a dynamic language that has inherent dynamic capabilities. As a result, runtime reflection and modification are easier to implement. By way of example, a JavaScript object already allows expando of instances and classes via prototypes and runtime code generation is already embedded by an “eval” function or equivalently an ability to dynamically generate “<script>” blocks. Fundamentally, dynamic features supported by a language are limited by an underlying runtime. Hence, additional dynamic features can be exposed in source languages by executing code on a dynamic runtime.

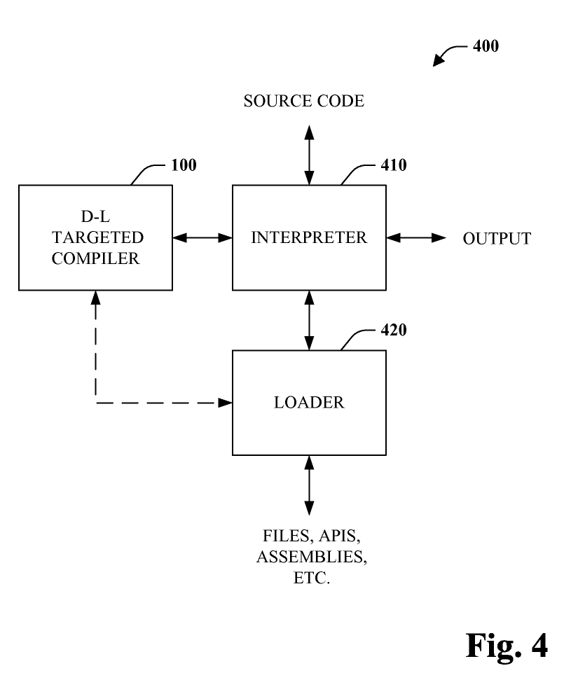

FIG. 4 depicts a dynamic runtime system 400 in accordance with an aspect of the claimed subject matter. System 400 includes an interpreter component 410 that employs conventional mechanisms to interpret and execute dynamic language code. In one instance, the dynamic language code can be produced at compile time by a dynamic language target compiler 100, as previously described. However, where code is to be generated or extended at runtime such code and/or associated metadata is not compiled at compile time by definition. Thus, the code should be compiled to dynamic code at runtime. To accomplish this task, the interpreter component can interact with dynamic language target compiler 100.

The dynamic language target compiler 100 can be the same as that previously described and employed at compile time just modified for runtime execution. In particular, the runtime version can be generated utilizing a compiler bootstrapping process where the compiler is compiled with itself. Specifically, if a dynamic language targeted compiler is written in language “A” it can be compiled from “A” to IL. Now, a compiler exists in IL that can compile IL to a dynamic language. At this point, a copy of that compiler is compiled to a dynamic language resulting in an IL to dynamic language compiler specified in the dynamic language. This guarantees that the code generated at runtime is the same or as correct as that generated at compiler time. As a result, compiler 100 can be utilized as a runtime component. Previously the compiler 100 was a tool for a developer's machine, now the compiler 100 can be a component that can run on any user's machine. Furthermore, bootstrapping the compiler 100 saves a lot of work, as a different runtime compiler need not be produced to do runtime code generation.

Further yet, it is to be noted that the entire dynamic language target compiler 100 need not be utilized as a runtime component as it may be unnecessarily large especially for embedding in a browser or loading thereby. Alternatively, a subset of the compile time compiler can be employed. The portion of the compiler utilized as a runtime component can be dependent upon functionality allowed or enabled to be generated at runtime.

In operation, where the interpreter component 410 encounters a portion of code that needs to be generated, the compiler 100 can be invoked to transform the code and optionally initiate execution thereof. For instance, dynamic language code can be generated and added as a parameter to an “eval” function or the like, which triggers evaluation of the code.

Code can also be inserted at runtime from an external source. For instance, code can point to other code (e.g., assembly) at runtime. Load component 420 facilitates loading external code for dynamic execution. In one instance, such code can be compiled to the dynamic language for execution utilizing compiler 100, where the code is not specified in the dynamic language but rather that of the source code (e.g. IL).

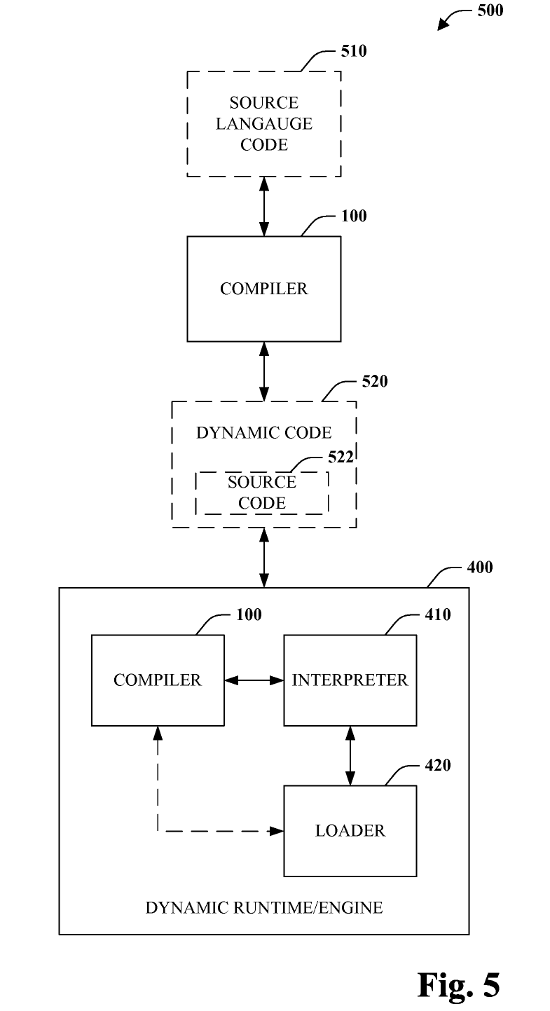

Referring briefly to FIG. 5, a program execution system 500 is illustrated. Source code 510 corresponds to code desired to be executed dynamically. In one instance, this can correspond to static structured language code or an intermediate language representation thereof. However, the claimed subject matter is not so limited. The compiler 100 can receive or retrieve the source code 510 transform it to dynamic code 520. As shown, the source code 510 need not be completely compiled statically. A portion of the source code 522 can remain. This portion can include a description of code to be produced and/or metadata, among other things. The runtime system 400 receives or retrieves the dynamic code 520 for execution. As previously described with respect to FIG. 4, the interpreter component 410 can interpret and execute the dynamic code 520. During execution, if code needs to be materialized, the runtime compiler 100 can transform source code language to dynamic code. In one scenario, the source code 522 can be provided as a parameter to an “eval” function, the compiler 100 invoked to transform the source code 522 to dynamic code and the dynamic code executed. Furthermore and as previously mentioned other code can be loaded dynamically and executed with or without assistance from the runtime compiler 100.

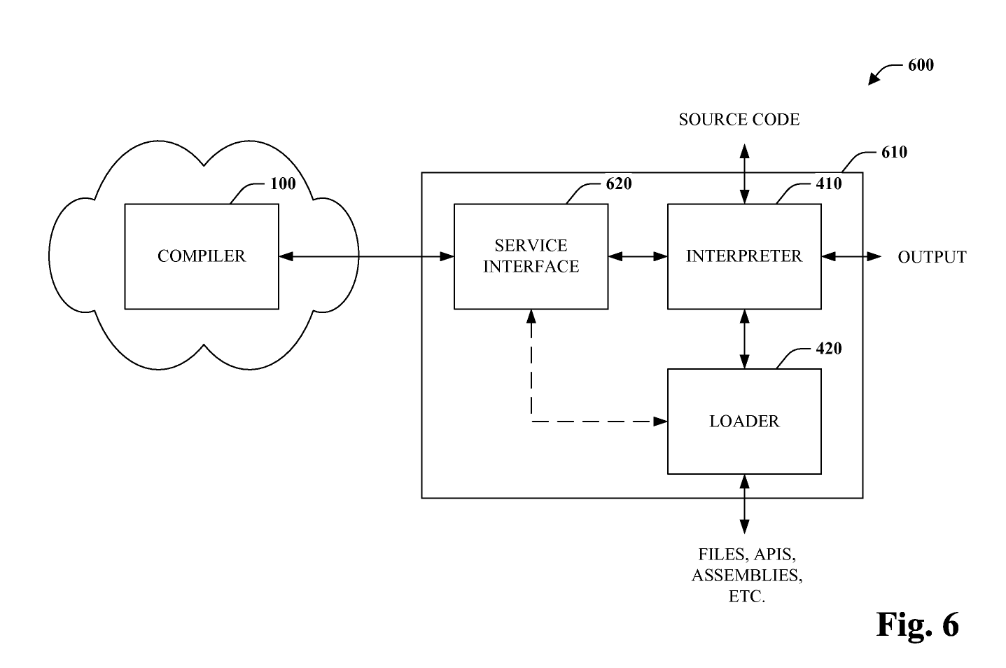

Turning attention to FIG. 6, a dynamic runtime system 600 is illustrated in accordance with an aspect of the claimed subject matter. Similar to system 400 of FIGS. 4 and 5, the system 600 includes the interpreter component 410 and loader component 420, as described above. In brief, the interpreter component 410 interprets and executes dynamic language code, and the loader component 420 facilitates loading or provisioning external code to the interpreter component 410. In some cases, a compiler is also required to translate runtime-generated code to a target dynamic language to enable execution thereof One way of providing such functionality is to make the compiler a component of the dynamic runtime or associated application (e.g., web browser . . . ), as previously described.

Another manner of accessing this functionality is via a service. More specifically, the dynamic language target compiler 100 can be positioned external to the runtime and accessed as a web service, for instance. Accordingly, system 600 includes a dynamic runtime system or component 610 including the interpreter component 410, the load component 420 and a communicatively coupled service interface component 620. The service interface component 620 is a mechanism for interacting with the remote compiler 100. More particularly, the interpreter component 410 and/or load component 420 can provide or otherwise identify code to the service interface component 620. The service interface component 620 can then issue a request to the compiler 100 to compile the code and return the compiled code to the service interface component 620. Once returned, the code can be executed by the interpreter component 410 or otherwise processed. This is advantageous because the compiler component 100 can be quite large such that it could be problematic to embed or load the compiler 100 into the runtime, especially where memory space is an issue.

To facilitate further clarity and understanding, consider an example illustrating how dynamic features can be realized conventionally. The following pseudo code snippet that utilizes an application programming interface (API) to allow users to dynamically create new methods that are logically associated with a given type:
Dim M=New DynamicMethod(“F”, GetType(Void), new Type( ){GetType(System.String)}, . . . )
Dim IL=M.GetILGenerator( )
. . . generate code by calling methods on IL . . .
. . . compile dynamic methods into delegate . . .
F As Action(Of String)=M.CreateDelegate(GetType(Action(Of String))
   Here, IL code can be generated at runtime utilizing the “GetILGenerator( )” function/method. A delegate is also created for the generated code to allow access/calling thereto. To implement this functionality, a conventional runtime has to do a lot of work essentially exposing an internal JIT (just-in-time) compiler interface to the “DynamicMethod” library—essentially attempting to simulate a dynamic runtime. In sum, a designated portion of code is compiled by the JIT compiler into executable code that is then wrapped in a delegate.

The implementation can be much simpler executing such code on a dynamic runtime. Once the code is transformed into dynamic code, available runtime functionality such as an “eval” function can be utilized to compile/interpret and execute the code. In effect, work that would be required to do this runtime code generation is factored out by using as much of the runtime code generation that the dynamic language already supports.

As previously mentioned, disclosed aspects of the claimed subject matter not only enable more efficient implementations of conventional runtime functionality. They also allow runtime system features to be exposed to original source languages. In other words, the dynamic nature or features of an underlying runtime can be exposed to an upper level. By way of example and not limitation, rather then requiring specification of runtime code in IL, the code can be specified with respect to the dynamic language. Further yet, an “eval” function can be exposed in a source language. For instance, an “eval” parameter can include a VB, C# or Java string, that can be compiled to IL and then from IL to a dynamic language such as JavaScript. Similarly, the “eval” parameter can simply include a JavaScript string, for example. Still further yet, it is to be appreciated that external source code can be generated in or translated to a dynamic language such that the code can be executed without the need for compilation.

It is also to be appreciated that dynamic languages can include the ability to delete code and/or data. Accordingly, not only can code be added or extended code, but it can also be removed as well. The manner in which this is accomplished can vary as a function of dynamic language. In ECMAScript and dialects thereof, every object is represented as a table (e.g. hash table) that includes properties each of which can be deleted. A source language type system can be expressed or represented as an object in a target dynamic language that has properties, namely all the classes or types. Accordingly, a class or type can be deleted by deleting a property from an object that represents the type system. A garbage collector can subsequently remove everything that is part of the deleted type. Again, a feature of the target language and/or dynamic runtime, deletion, can be leveraged and exposed upward. Among other things, this feature can be quite useful in space sensitive platforms such as mobile phones.

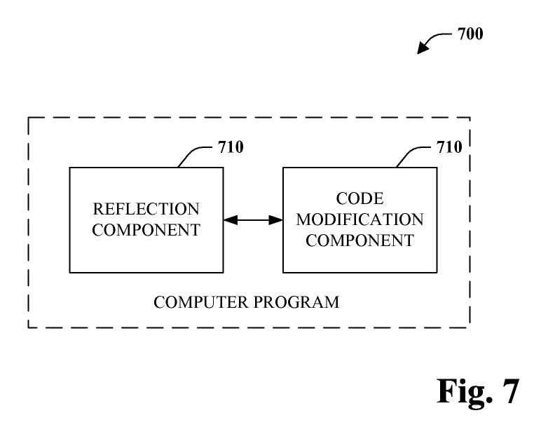

Referring to FIG. 7, a block diagram of a computer program 700 is depicted in accordance with an aspect of the claimed subject matter. Among other things, the computer program can include a runtime reflection component 710 and a code modification component 720. The reflection component 710 is a mechanism for acquiring runtime state information or metadata. In effect, reflection component 710 allows a program to observe or reflect on itself. As a simple example, reflection component 710 can enable a program to request all methods of a class. A list of methods can then be returned which can be enumerated to locate and potentially call particular method. The code modification component 720 is able to modify programmatic code at runtime via addition, extension, deletion, alteration or the like. For instance, the code modification component 720 can add a method to a class, delete a method from a class or alter a method implementation. The reflection component 710 and the modification component 720 can interact. For example, the reflection component 710 can identify additions to code afforded by the modification component 720, and the modification component 720 can utilize information about the code from the reflection component 710 to make changes.

The computer program 700 can correspond to a program specified in a source language. By targeting a dynamic runtime, such dynamic functionality can be exposed in source languages. Accordingly, conventionally static languages can now afford runtime reflection can code modification while also preserving its static nature. Furthermore, it is to be appreciated that dynamic reflection and code modification functionality can be captured or encapsulated in one or more application programming interfaces (APIs) or libraries to facilitate specification thereof. For instance, an API can include a reflection method and/or a code modification method.

In accordance with one aspect, classes or types, among other programmatic constructs, can be modified dynamically. In conventional languages, there is a notion of extension or expando methods where new methods are added to existing classes. One problem with these methods is that due to restrictions on the runtime or execution engine such methods can only be added at compile time. In other words, a limitation of the runtime is addressed by adding more compile time support. However, such compile time support does not enable runtime support. Accordingly, if a type is reflected over, extension members are not visible. Adding runtime support for extension methods would be really difficult in general because conventional static runtimes do not allow changes to a type after the fact. Of course, in dynamic languages this is possible. Executing code over a dynamic runtime enables true extension methods since new members can be added to a type or class at runtime. Conventional attempts are merely hacks because there is no way to actually change object instances. Now, however, this is possible.

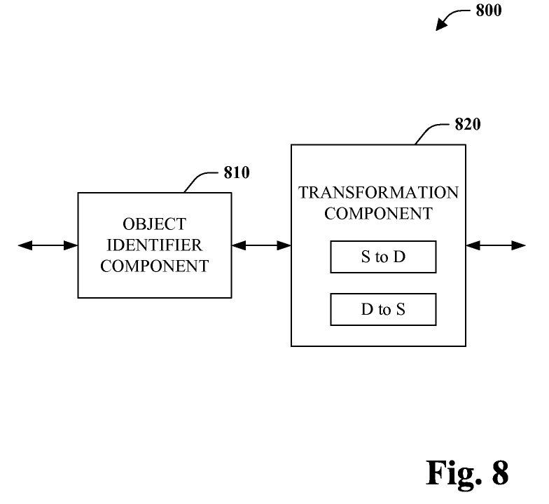

FIG. 8 depicts a data marshalling system 800 in accordance with an aspect of the claimed subject matter. When compiling from a source language such as IL to a target dynamic language such as JavaScript, it is important to support interoperability between the languages. In JavaScript, for example, a JavaScript object specified in JavaScript Object Notation (JSON) is used as a transport mechanism between web services, while IL can interact with a different type of object. The data marshalling system 800 provides is a mechanism for transforming objects from one style to another style such that source language programs can process dynamic language objects and vice versa.

The system 800 includes an object identifier component 810 and a transformation component 820. The object identifier component 810 receives, retrieves or otherwise identifies an object. The object can be either a source language object (e.g., static object) or dynamic language object. The object identifier component 810 can identify, transmit or otherwise make an object available to the transformation component 820. The transformation component 820 provides a mechanism to transform an object from either source to dynamic or dynamic to source. This can be a true transformation or morphing of one object into another or alternatively a new object can be created. In one instance, a source language object, such as one associated with a structured object-oriented language, can require addition metadata. Accordingly, the transformation component 820 can enhance a dynamic object by injecting such metadata including one or more fields and/or methods, for instance. In one case, metadata can be added to a primitive objects provided by an underlying runtime up until a point where a contract with an embedded runtime is satisfied. Transforming in the opposite direction can involve simply stripping out the added information.

Further, it should be appreciated that to ensure conversion is idempotent, that is repeated applications of the same effect as one, the transformation component 820 can check to see if a particular object is already of a desired state and just return it rather than attempting to further transform an object. Marshalling an object twice should be the same as marshalling an object once and un-marshalling an object once should be the same as twice.

It is also to be noted that previously described systems and/or techniques can be utilized to transform objects dynamically. For example, dynamic code generation can be utilized to add data to objects at runtime. Dually, properties of a source type can be identified utilizing reflection and subsequently removed to generate a dynamic object. Hence, it is easy to transform objects back and forth by adding or removing fields or other programmatic constructs. Again, this can leverage the dynamism of a dynamic runtime.

There are many ways in which the transformation component 820 can transform an object. In one implementation, a dynamic language object can simply be transformed into a generic source object with generic accessor methods. In an alternative implementation, a dynamic language object can be analyzed at runtime and specific source objects or types generated or derived as a function of thereof.

By way of example, consider marshalling JSON objects to a structured language objects. One manner of accomplishing this task is to wrap any JSON object as a generic structured language object and add some generic methods to access JSON properties as follows:

```
class JSON
{
    [JSImport(Function = “”)] // [JSImport(Function =
    “function(x){ return x; }”)]
    extern public JSON(object x);
    ... indexer for accessing properties ...
}
```

However, utilizing regular reflection would not allow viewing of all available members of the JSON object. When the JSON value “var x={“a”: 5, “f”: function(x) {return this+x;}}” is wrapped for instance, it is desirable to expose it as a proper structured language object that has a field (or property) “a”, and a method “f” (or perhaps a field or property of delegate type).

In JavaScript, one can iterate over all (visible) members of an object and retrieve their name and type. The example below will show “a: 5, typeof=number” and “f: function(x) { . . . }, typeof=function”:

for(var i in x)
{
WScript.Echo(i +“: ”+ x[i] + “type = “+, typeof x[i]);
}

Based on this information, when the JSON object is wrapped as a structure language object, a dynamic type descriptor can be generated at runtime that will make the JSON object look like a regular structured language object type (e.g., that inherits from JSON). Now normal reflection can be performed over the object, in particular late binding

Dim X As Object = new JSON(...)
Console.WriteLine(X.f(7)) REM prints 13

A few examples were provided above to illustrate particular aspects of the claimed subject matter. Some additional examples or use cases for aspects are provided below. It should be appreciated that the claimed subject matter is not limited thereto. Many other examples or use cases are possible and should be considered within the scope of invention.

One particular problem with conventional computer systems is that when code needs to be changed or updated the system needs to be rebooted. This is a byproduct of static language systems. Running code cannot be changed dynamically. A system needs to close an application, modify the application and restart. Dynamic languages do not have this limitation. By embedding a static language and runtime within a dynamic language and runtime, this issue disappears. In one instance, an entire operating system can be implemented on top of a dynamic runtime. Any updates to the operating system can then be done during execution without necessitating a reboot. Similarly, security patches and device driver updates can be installed without requiring a reboot where the associated applications are executed on a dynamic runtime in accordance with an aspect of the claimed subject matter.

Runtime method interception and aspect weaving can also be done utilizing aspects of described subject matter. Conventionally, aspect oriented programming provides for compile time customization. For instance, a specification is developed that says overwrite method “X,” add functionality around method “Y,” wrap and/or thunk something else, etc. However, all this is done as a rewrite of compile time code. Now, the same thing can be done but at runtime.

Further, conventional load time profile APIs can instrument only the first time a method is given. Hence, profiling scenarios are limited to the first time a method compiles. Utilizing aspects of the claimed subject matter, any method can be instrumented any time. In this manner, a method can be instrumented to analyze and collect profile information. This can be run for a while and then changes can be made based on the profile information. Further, this can be implemented to enable self-profiling.

Similarly, afforded dynamism can be leveraged for working set reduction and optimization. Working set reduction focuses on small platforms and reducing and optimizing code. By dynamically profiling, a program or individual can determine which pairs of methods or operations go together and then the memory can be reorganized is that if method “A” and method “B” are always called together, they can be put together in memory. This reduces thrashing and the working set size, which is hugely important for small platforms or any system under memory pressures. This can be done with data, methods or code, among other things.

Forward compatibility is also enabled by the dynamism. For example, one may desire to run a piece of code on a platform that does not natively support it. The original code can detect this at runtime and dynamically modify itself utilizing thunks and/or the like to support execution on the platform.

The dynamism of the claimed subject matter can also be beneficial in testing and debugging. In particular, a piece of code can be modified to include debugging information similar to the manner it is modified to insert profile information. Debugging hooks can then provide a means for performing offline monitoring, control, diagnostics and/or running of the program. In one instance, random data can be inserted to make sure an API, method or the like accepts the data or generates an error rather than crashing or carrying on with garbage data. Conventionally, testing requires wrappers be written to call the code and pass test data. However, it is very difficult to test an underlying API especially when assembly re-writing needs to be done. Here, a method can be modified to return test data to see what happens. Fault injection and/or fuzz testing can be accomplished in a similar manner. For example, a method can be altered to return a particular or random value. This allows for runtime testing as opposed to compile time testing. Furthermore, very dynamic fuzzing or fault injection can be performed where the fault moves around code.

While dynamism associated with runtime code modification may invite security problems, it also enables advanced security mechanism to combat these and other threats. For example, code can be instrumented to detect intrusion or other security issues such as cross-site scripting. Where a threat is detected, the code can sandbox itself or prevents certain operations. The code can also be modified to provide runtime obfuscation. In this manner, even though people might have some way to inspect code, it can periodically be re-written or moved such that buffer overruns or other activities that rely on certain patterns will be at the least very difficult. Code can thus be made less predictable and less vulnerable to attack.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the compiler 100 can include such mechanism with respect to generating semantically accurate as well as performance-optimized code. Similarly, various applications can utilize machine learning with respect to working set reduction, code analysis, optimization, forward compatibility, testing and debugging and/or security, among others.

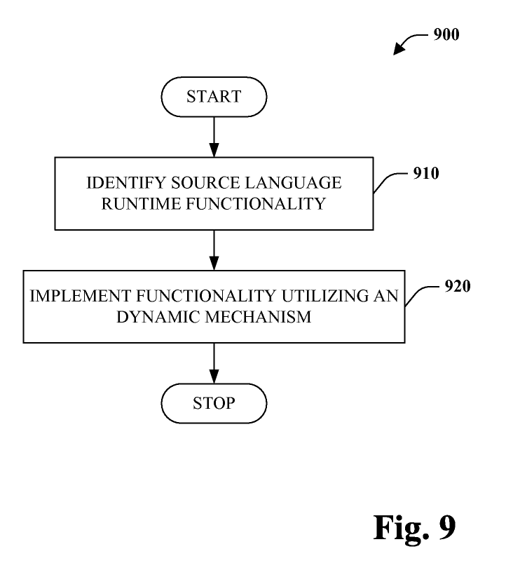

In view of the exemplary systems described supra, methodologies that may be implemented in accordance with the disclosed subject matter will be better appreciated with reference to the flow charts of FIGS. 9-12. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 9, a method of program compilation 900 is depicted in accordance with an aspect of the claimed subject matter. At reference numeral 910, source language runtime functionality is identified. Runtime functionality can correspond to reflection and dynamic code modification (addition, deletion, alteration . . . ), among other things. The source language functionality can be specified in structured, object-oriented, statically typed and/or strongly typed code, among other things. For example and not limitation, the source language can be Visual Basic, C#, Java or an intermediate language representation thereof. At reference numeral 920, identified runtime functionality is implemented utilizing a dynamic mechanism. In accordance with one implementation, the functionality can be mapped to a dynamic language and executed on a dynamic language runtime. For instance, the dynamic language and associated runtime can correspond to ECMAScript, dialects thereof, Perl, Ruby and Smalltalk, inter alia. In one instance, the method 900 can map compile time or static reflection and/or code modification to runtime or dynamic reflection and/or code modification. In an embodiment, the mapping can be performed as part of a complete translation of a source language to a dynamic language. In other words, the mapping can be a component of an embedding of a source language runtime into a target dynamic language and corresponding runtime.

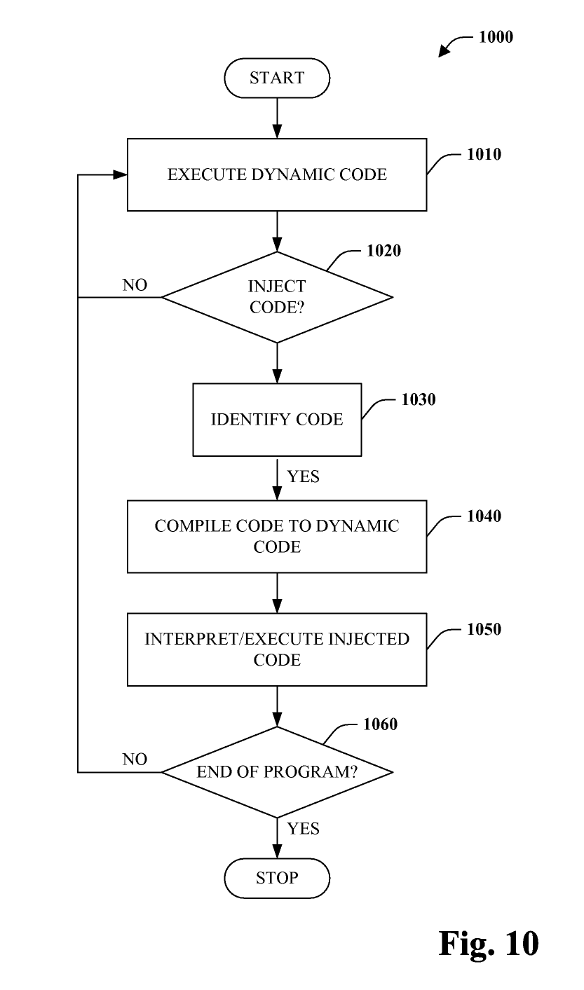

FIG. 10 is a flow chart diagram illustrating a method of program execution 1000 in accordance with an aspect of the claimed subject matter. At reference 1010, dynamic language code is executed. Such code can correspond to a translation of a source language code and runtime implementation. At reference numeral 1020, a determination is made as to whether runtime code is to be injected. This determination can be a function of program execution or additional functionality (e.g., code analysis, optimization, working set reduction, testing . . . ). If at 1020, it is determined that no code is to be injected, the method 1000 can continue at 1010 where dynamic code continues to execute. Otherwise, the method 1000 proceeds to numeral 1030 where code to be injected is identified from within the code itself or external thereto, for example. At reference numeral 1040, identified code in a source language is compiled or translated to the dynamic language of the executing code. The compiled code is then interpreted and executed at numeral 1050. At reference 1060, a determination is made concerning whether the end of the executing program has been reached. If yes, the method 1000 terminates. If no, dynamic code continues to be executed at reference 1010.

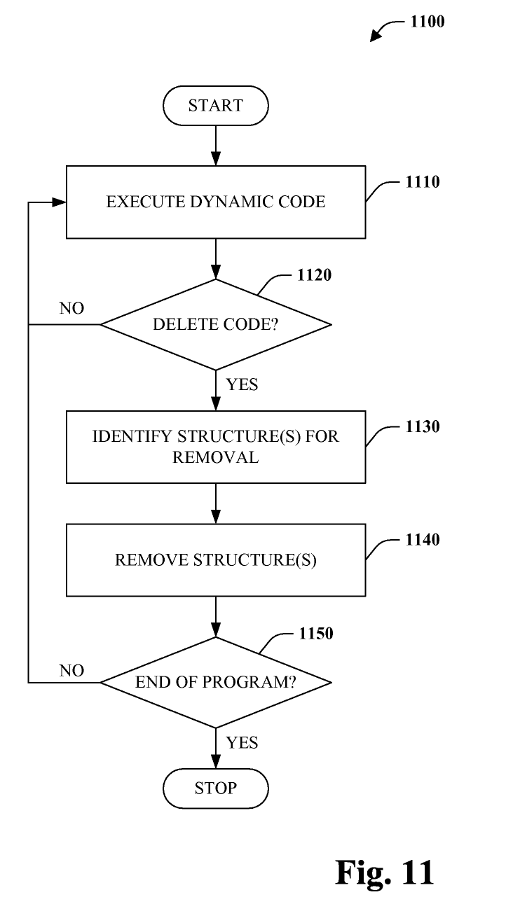

FIG. 11 depicts a method of program execution in accordance with an aspect of the claimed subject matter. At reference numeral 1110, a dynamic language code or program is executed. In one embodiment, the dynamic code can correspond to a translation of code in another programming language such as a static, strongly typed language. At numeral 1120, a determination is made concerning whether code should be deleted. This determination can be based on optimization and/or memory concerns, among other things. For example, small platforms systems can have memory constraints. In order to respect those constraints, portions of an executing program may need to be removed. Alternatively, unused code or code not likely to be executed can be removed. At reference 1130, one or more code segments or structures are identified for removal. The identified code is then removed at numeral 1140. At 1150, it is determined whether the end of the program or code has been reached. If yes, the method 1100 terminates. If no, the method 1100 proceeds at reference numeral 1110 wherein dynamic code is executed.

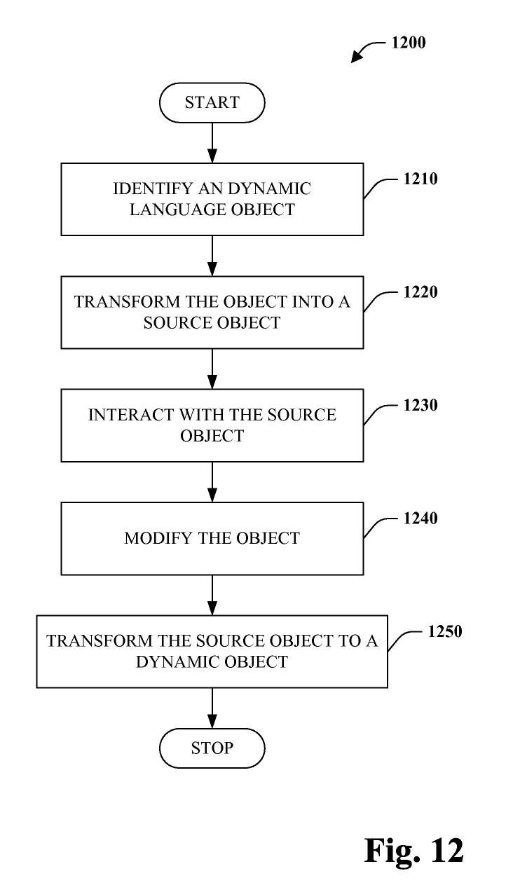

FIG. 12 is a flow chart diagram of a method of program language interaction 1200 in accordance with an aspect of the claimed subject matter. At reference numeral 1210, a dynamic language object is identified. In one instance, this can correspond to a JavaScript object specified in JSON. At numeral 1220, the dynamic object is transformed into a source language object. For example, the source language can be a structured object oriented language and the transformation can add required metadata including code and/or data to a more primitive dynamic language object. It should also be noted that as an alternative to transforming a given object a new object could be produced. At numeral 1230, the source language object is interacted with or processed. The object can be modified at reference numeral 1240 as a result of the processing, for instance. At reference numeral 1240, the source object is transformed back into a dynamic language object, or alternatively a dynamic language object is produced from the source object, for dynamic program use or transmission, for example.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

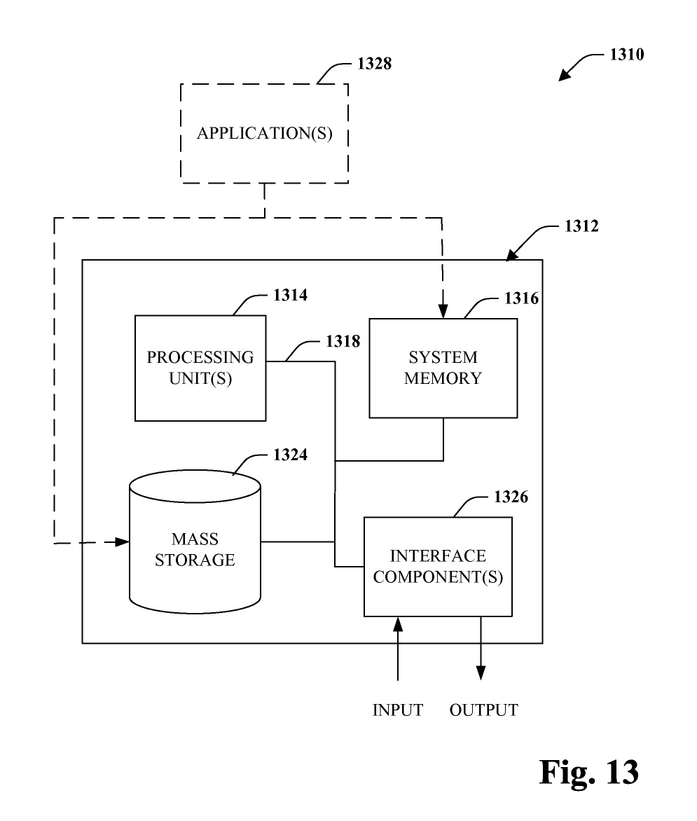

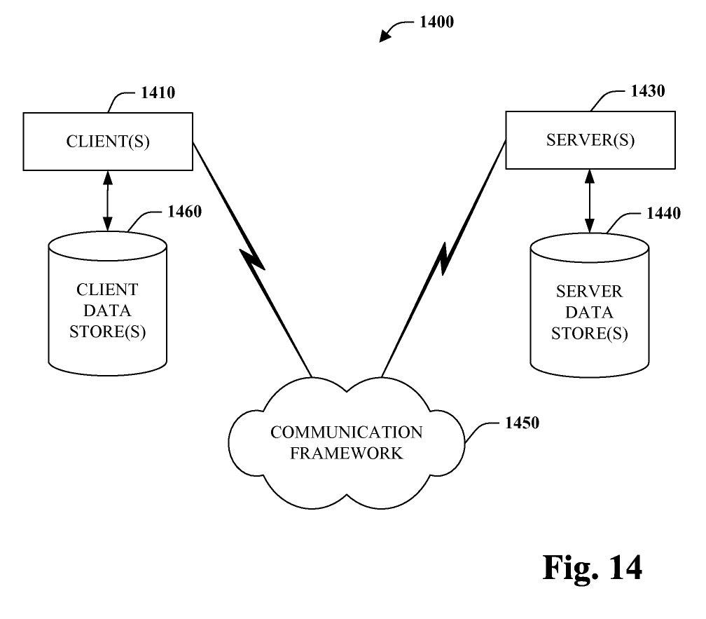

In order to provide a context for the various aspects of the disclosed subject matter, FIGS. 13 and 14 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 13, an exemplary environment 1310 for implementing various aspects disclosed herein includes a computer 1312 (e.g., desktop, laptop, server, hand held, programmable consumer or industrial electronics . . . ). The computer 1312 includes a processing unit 1314, a system memory 1316 and a system bus 1318. The system bus 1318 couples system components including, but not limited to, the system memory 1316 to the processing unit 1314. The processing unit 1314 can be any of various available microprocessors. It is to be appreciated that dual microprocessors, multi-core and other multiprocessor architectures can be employed as the processing unit 13 14.

The system memory 1316 includes volatile and nonvolatile memory. The basic input/output system (BIOS), containing the basic routines to transfer information between elements within the computer 1312, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1312 also includes removable/non-removable, volatile/non-volatile computer storage media. FIG. 13 illustrates, for example, mass storage 1324. Mass storage 1324 includes, but is not limited to, devices like a magnetic or optical disk drive, floppy disk drive, flash memory or memory stick. In addition, mass storage 1324 can include storage media separately or in combination with other storage media.

FIG. 13 provides software application(s) 1328 that act as an intermediary between users and/or other computers and the basic computer resources described in suitable operating environment 1310. Such software application(s) 1328 include one or both of system and application software. System software can include an operating system, which can be stored on mass storage 1324, that acts to control and allocate resources of the computer system 1312. Application software takes advantage of the management of resources by system software through program modules and data stored on either or both of system memory 1316 and mass storage 1324.

The computer 1312 also includes one or more interface components 1326 that are communicatively coupled to the bus 1318 and facilitate interaction with the computer 1312. By way of example, the interface component 1326 can be a port (e.g., serial, parallel, PCMCIA, USB, FireWire . . . ) or an interface card (e.g., sound, video, network . . . ) or the like. The interface component 1326 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1312 to output device(s) via interface component 1326. Output devices can include displays (e.g. CRT, LCD, plasma . . . ), speakers, printers and other computers, among other things.

FIG. 14 is a schematic block diagram of a sample-computing environment 1400 with which the subject innovation can interact. The system 1400 includes one or more client(s) 1410. The client(s) 1410 can be hardware and/or software (e.g., threads, processes, computing devices). The system 1400 also includes one or more server(s) 1430. Thus, system 1400 can correspond to a two-tier client server model or a multi-tier model (e.g., client, middle tier server, data server), amongst other models. The server(s) 1430 can also be hardware and/or software (e.g., threads, processes, computing devices). The servers 1430 can house threads to perform transformations by employing the aspects of the subject innovation, for example. One possible communication between a client 1410 and a server 1430 may be in the form of a data packet transmitted between two or more computer processes.

The system 1400 includes a communication framework 1450 that can be employed to facilitate communications between the client(s) 1410 and the server(s) 1430. The client(s) 1410 are operatively connected to one or more client data store(s) 1460 that can be employed to store information local to the client(s) 1410. Similarly, the server(s) 1430 are operatively connected to one or more server data store(s) 1440 that can be employed to store information local to the servers 1430.

For example, client(s) 1410 can execute dynamic code derived from a static and strongly typed code within a web browser. Additional code can be acquired from one or more server(s) 1430 over the communication framework 1450 and injected into runtime code execution. Where this additional code is specified in the source language, this code can be compiled to dynamic code and subsequently interpreted utilizing a local compiler resident on a client 1410 or a remote compiler provided as a service on server(s) 1420. Additionally or alternatively, dynamic language objects can be acquired by the client(s) 1410 from server(s) 1420 over communication framework 1450 and transformed to source language code to facilitate processing.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A runtime code system, comprising:
an interface component that acquires static code that specifies runtime functionality; and
a translation component that translates the static code to dynamic code for execution in a dynamic runtime environment.

2. The system of claim 1, further comprising a map component that maps the structured static code to unstructured dynamic language constructs.

3. The system of claim 2, the dynamic language constructs include prototypes and/or evaluation operations.

4. The system of claim 1, at least one of the interface and translation components form part of a runtime environment component.

5. The system of claim 4, the runtime environment component includes a subset of functionality available statically.

6. The system of claim 1, at least one of the interface and translation components form part of a web service employable by the dynamic runtime environment.

7. The system of claim 1, the dynamic code includes at least a portion of static code to be translated at runtime.

8. The system of claim 1, further comprising a load component that provides static code from outside a dynamic language program to be translated at runtime.

9. The system of claim 1, the static code is intermediate language code common to one or more program languages.

10. The system of claim 1, the dynamic code is script code.

11. A method of computer program execution, comprising:
dynamically translating statically typed language code to dynamically typed language code; and
interpreting the dynamically typed code.

12. The method of claim 11, further comprising generating dynamically typed language code at runtime.

13. The method of claim 11, further comprising loading dynamically typed code from an external source at runtime.

14. The method of claim 11, further comprising transforming a statically typed object to a dynamically typed object.

15. The method of claim 11, further comprising adding a class, class member or instance thereof.

16. The method of claim 11, further comprising deleting a class, class member or instance thereof.

17. A system for supporting runtime code modification, comprising:
means for identifying statically typed language code to be injected into a script during execution thereof; and
means for translating the statically typed language code to script language code at runtime.

18. The system of claim 17, further comprising a means for generating the statically typed language code at runtime.

19. The system of claim 17, further comprising means for loading the statically typed language code from a source outside the script.

20. The system of claim 17, further comprising a means for translating statically typed language code to script code at compile time.
